(19) United States
(12) Patent Application Publication
(10) Pub. No.: US 2016/0208724 A1
(43) Pub. Date: Jul. 21, 2016

(54) METHOD OF ENERGIZING A SOLENOIDAL FUEL INJECTOR FOR AN INTERNAL COMBUSTION ENGINE

(71) Applicant: GM GLOBAL TECHNOLOGY OPERATIONS LLC, Detroit, MI (US)

(72) Inventors: Massimiliano MELIS, Rivoli (IT); Francesco PESCE, Torino (IT); Gennaro MERLINO, MERLINO (IT); Lucio POSTRIOTI, Perugia (IT)

(73) Assignee: GM GLOBAL TECHNOLOGY OPERATIONS LLC, Detroit, MI (US)

(21) Appl. No.: 14/994,535

(22) Filed: Jan. 13, 2016

(30) Foreign Application Priority Data
Jan. 15, 2015 (GB) 1500637.2

(51) Int. Cl. F02D 41/20

(52) U.S. Cl. CPC F02D 41/20; F02D 2041/2013

(57) ABSTRACT

A method and apparatus for energizing a solenoidal fuel injector for an internal combustion engine is disclosed. The fuel injector is electrically connected to a battery capable of providing a battery voltage and to a boost converter capable of providing a boost voltage that is higher than the battery voltage. The boost voltage is applied to a solenoid of the fuel injector to perform a first opening phase of the injector, the energy from the solenoid of the fuel injector is then discharged. A second opening phase of the fuel injector is performed, and followed by a hold phase using the battery voltage (V_{batt}). Lastly, a closing phase of the fuel injector is performed.

### CROSS-REFERENCE TO RELATED APPLICATION

This application claims priority to Great Britain Patent Application No. 15006372, filed Jan. 15, 2015, which is incorporated herein by reference in its entirety.

### TECHNICAL FIELD

The present disclosure pertains to a method of energizing a solenoidal fuel injector of an internal combustion engine.

### BACKGROUND

It is known that a conventional fuel injection system for an internal combustion engine includes a fuel rail and a plurality of electrically controlled fuel injectors, which are hydraulically connected to the fuel rail by respective feeding conduits. Each fuel injector generally includes a fuel inlet, a fuel outlet and a movable needle which repeatedly opens and closes the fuel outlet. When the needle is in an open position, fuel is injected under pressure into a cylinder of the internal combustion engine. In solenoidal fuel injectors, the movable needle is actuated with the aid of a dedicated solenoid actuator acting as a control valve and which is driven by an electric current controlled by an Electronic Control Unit (ECU).

When the solenoid actuator is supplied with electric current, it generates a magnetic field which lifts the valve needle off of its seat to allow fuel to flow through the fuel injector and to leak out of the nozzle towards the combustion chamber of the associated cylinder. When the fuel injector is de-energized, namely electrical current is no longer sent to the solenoid actuator, the valve needle is pressed against the valve seat. Fuel injectors of this type may be used in common rail diesel engines or in gasoline direct engines.

As known in the art and schematically illustrated in FIG. 3, the profile of the current circulating into the solenoid of the fuel injector (curve A) is usually divided into phases including a “pull-in” phase, a “peak” phase, and a “hold” phase. During the pull-in phase, the current increases rapidly, supplied via a dedicated power supply called DC/DC boost converter that provides a voltage between 30V and 65V, 50V. Once the pull-in current is detected by the ECU, the voltage is switched off and the current recirculates via ground voltage e., 0 volt).

During the peak phase, the current is controlled between two preset current levels (“peak high current” and “peak low current”) by switching on and off the power supply to the solenoid: in this phase the power supply is typically a battery voltage. The current is similarly controlled in the “hold” phase between a “hold high current” and a “hold low current”. The manufacturer of the fuel injectors usually provides these pre-set current levels. The timing of these phases are also controlled by the ECU, which determines the key parameters for each injection pulse as a function of the quantity of fuel to be injected in the course of the injection pulse, taking into account the value of the pressure inside the fuel rail and, eventually, of other parameters.

In FIG. 3, a conventional injection rate profile (B) for a fuel injection is depicted. The injection rate profile B has a standard shape, vaguely resembling a bell curve. Solenoidal fuel injectors are generally less expensive than piezoelectric injectors, but are intrinsically limited as regards to the possibility to modulate fuel injection shape and the consequent heat release rate deriving, from fuel combustion. These factors may represent a strong limitation for several injection strategies, such as those injection strategies that are designed to improve the combustion efficiency, to provide better engine warm-up, a decreasing of oil dilution or a better management of the after-treatment devices. Furthermore, fuel injection rate shaping using solenoid fuel injector is limited, in some cases, by the deterioration of injected quantity repeatability due, for example, to the aging of the fuel injector.

### SUMMARY

In accordance with the present disclosure, a method is provided for energizing a solenoidal fuel injector in an internal combustion engine that modulates the conventional injector driving current profile control, in order to get an optimized shape of the rate of injection. Specifically, an embodiment of the present disclosure provides a solenoidal fuel injector for an internal combustion engine, the fuel injector being electrically connected to a battery capable of providing a battery voltage and to a boost converter capable of providing a boost voltage, the boost voltage being higher than the battery voltage. A boost voltage is applied to a solenoid of the fuel injector to perform a first opening phase of the injector. The energy from the solenoid of the fuel injector is discharged. A second opening phase of the fuel injector is performed. A hold phase using the battery voltage is performed. A closing phase of the fuel injector is performed. An effect of this embodiment is that, by allowing to modulate the shape of the fuel injection rate profile, a combustion efficiency improvement is achieved which leads to a sensible CO₂ reduction and to an improvement in the reduction of engine noise.

According to another embodiment of the present disclosure, the energy from the solenoid of the fuel injector is discharged by inverting the polarity of the boost voltage, and applying the inverted boost voltage to the solenoid of the injector. An effect of this embodiment is that it allows to rapidly discharging the energy from the solenoid of the injector.

According to another embodiment of the present disclosure, the energy from the solenoid of the fuel injector is discharged by preventing any voltage supply to the solenoid. An effect of this embodiment is that it allows to discharge the energy from the solenoid of the injector and reduce energy consumption at the same time.

According to a further embodiment of the present disclosure, the second opening phase of the injector is performed by applying a boost voltage to the solenoid of the fuel injector. An effect of this embodiment is that it allows to reduce the deviation of performance between different injections due to aging or to other factors.

According to another embodiment of the present disclosure, the second opening phase of the injector is performed by applying a battery voltage to the solenoid of the fuel injector, An effect of this embodiment is that it allows to improve the performance of the injector while, at the same time, having a simplified hardware.

According to another embodiment of the present disclosure, a peak phase is performed between applying a boost voltage to a solenoid of the injector to perform a first opening phase of the injector and applying an inverted boost voltage to the solenoid of the injector, a peak phase is performed. An effect of this embodiment is that it allows to obtain different injection shapes, depending on engine conditions or other parameters.

According to another embodiment of the present disclosure, an inverted boost voltage is applied to the solenoid of the fuel injector for a duration based on a desired fuel injection shape. An effect of this embodiment is that it allows to modulate the fuel injection shape.

The present disclosure also includes an apparatus for energizing a solenoidal fuel injector for an internal combustion engine, which is electrically connected to a battery capable of providing a battery voltage and to a boost converter capable of providing a boost voltage, the boost voltage being higher than the battery voltage. The apparatus is configured to apply a boost voltage to a solenoid of the fuel injector to perform a first opening phase of the injector, discharge the energy from the solenoid of the fuel injector, perform a second opening phase of the injector, perform a hold phase using battery voltage, and perform a closing phase of the injector.

According to another embodiment of the present disclosure, the apparatus is configured to discharge the energy from the solenoid of the fuel injector by inverting the polarity of the boost voltage and applying the inverted boost voltage to the solenoid of the injector. An effect of this embodiment is that it allows to rapidly discharging the solenoid of the injector.

According to another embodiment of the present disclosure, the apparatus is configured to discharge the energy from the solenoid of the fuel injector by preventing any voltage supply to the solenoid. An effect of this embodiment is that it allows to discharge the solenoid of the injector and reduce energy consumption at the same time.

According to a further aspect of the present disclosure, the apparatus is configured to perform the second opening phase of the injector by applying a boost voltage to the solenoid of the injector. An effect of this aspect is that it allows to reduce the deviation of performance between different injections.

According to another aspect of the present disclosure, the apparatus is configured to perform the second opening phase of the injector by applying a battery voltage to the solenoid of the injector. An effect of this aspect is that it allows to improve the performance of the injector while, at the same time, having a simplified hardware.

According to another aspect of the present disclosure, the electronic control unit is configured to perform a peak phase between applying a boost voltage to a solenoid of the injector to perform a first opening phase of the injector and applying an inverted boost voltage to the solenoid of the injector. An effect of this aspect is that it allows to obtain different injection shapes, depending on engine conditions or other parameters.

According to another aspect of the present disclosure, the apparatus is configured to regulate the duration of the phase of applying an inverted boost voltage to the solenoid of the injector is performed as a function of a desired injection shape. An effect of this embodiment is that it allows to modulate the fuel injection shape.

The method according to one of its aspects can be carried out with the help of a computer program including a program-code for carrying out all the steps of the method described above, and in the form of computer program product including the computer program. The computer program product can be embodied as a control apparatus for an internal combustion engine, including an electronic control unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 is a schematic illustration of a conventional fuel injection current and injection rate profile for a fuel injection;

FIG. 4 is a schematic illustration of a current profile for a fuel injection performed according to an embodiment of the present disclosure;

FIG. 5 is a schematic illustration of two injection rate profiles for two different fuel injection performed according to further embodiments of the present disclosure;

FIG. 6 is a schematic illustration of a circuit employed in the various embodiments of the present disclosure to generate a boost voltage;

FIG. 7 is a schematic illustration of a current profile for a fuel injection performed according to still another embodiment of the present disclosure; and

FIG. 8 is a flowchart representing an embodiment of a method of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

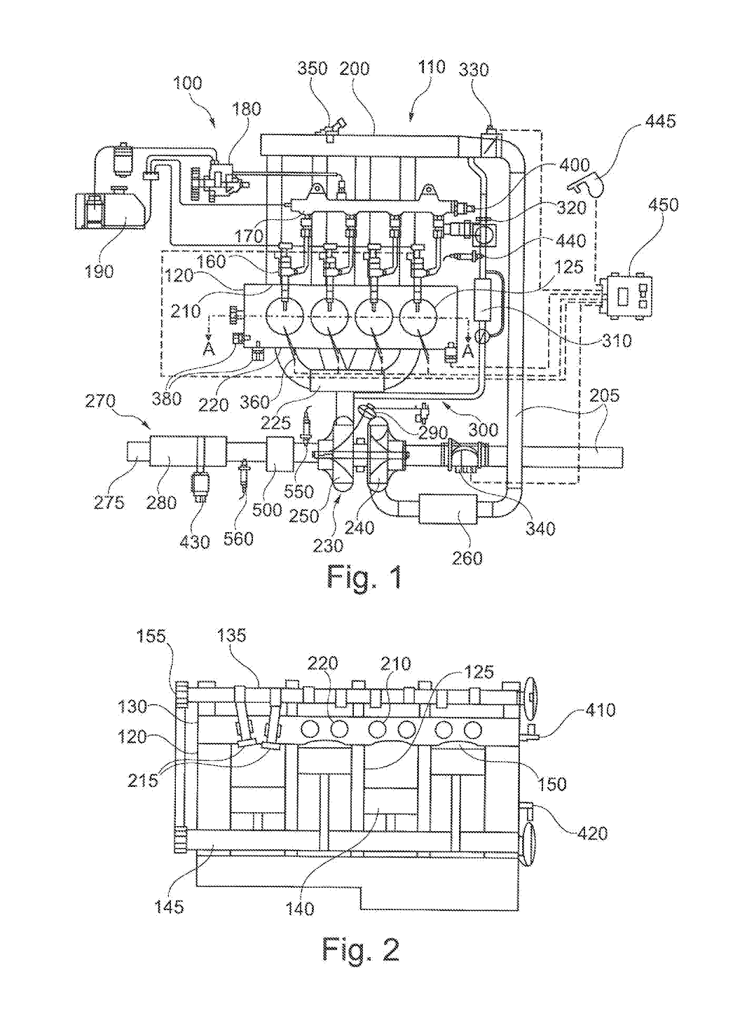

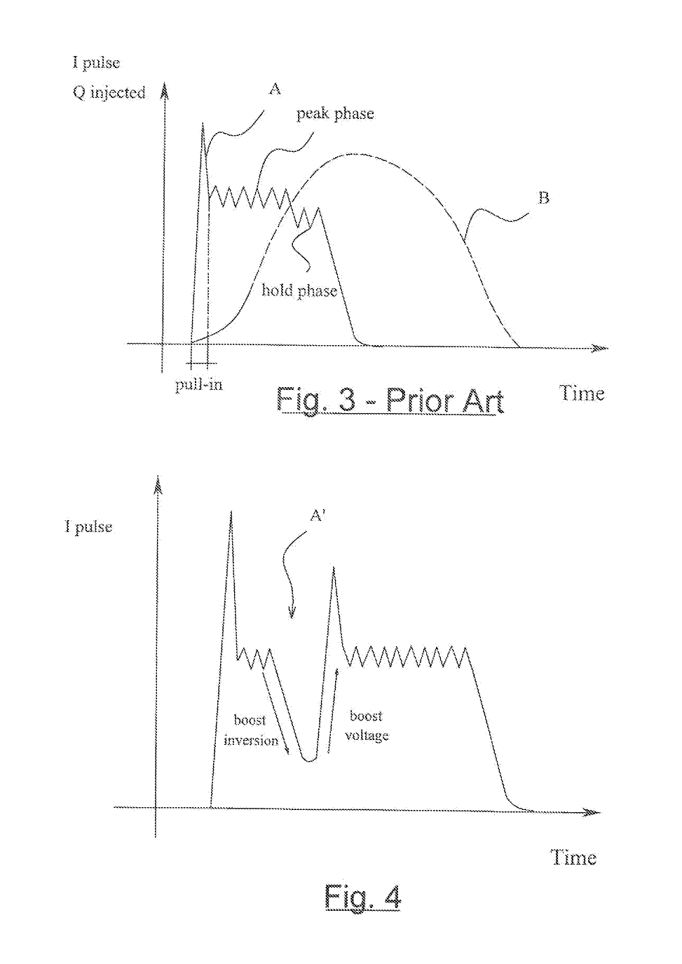

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140, The fuel is provided by at least one fuel injector 160 equipped with a solenoid 165 and the air through at least one intake port 210. The fuel is provided at high pressure to the fuel injector 160 from a. fuel rail 170 in fluid communication with a high pressure fuel pump 180 that increases the pressure of the fuel received from a fuel source 190. In case of solenoidal injectors, each fuel injector 160 is equipped with a solenoid 165 and a movable needle 167 actuated with the aid of the solenoid 165 acting as a control valve which is driven by an electric current controlled by an Engine Control Unit (ECU) 450.

Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200, An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may he provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may he fixed geometry and/or include a waste gate.

The exhaust gases of the engine are directed into an exhaust system 270. The exhaust system 270 may include an exhaust pipe 275 having one or more exhaust after treatment devices 280. The after treatment devices may be any device configured to change the composition of the exhaust gases. Sonic examples of after treatment devices 280 include, but are not limited to, catalytic converters (two and three way), oxidation catalysts, lean NO traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated. with the ICE 110. The ECU 450 may receive input signals from various sensors configured to generate the signals in proportion to various physical parameters associated with the ICE 110. The sensors include, but are not limited to, a mass air flow and temperature sensors 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR. Valve 320, a Variable Geometry Turbine (VGT) actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carry out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

Referring now to FIG. 4, a schematic illustration of a current profile A′ of a fuel injection performed according to an embodiment of the present disclosure, is represented. The current profile of the embodiment shown in FIG. 4 is created by energizing the solenoid 165 of the fuel injector 160 either by employing a battery 500, capable of providing a battery voltage V_{batt}, or by employing a boost converter 520, capable of providing a boost voltage V_{boost}, wherein the boost voltage V_{boost} is higher than the battery voltage V_{batt}.

The profile of the current circulating into the solenoid 165 of the fuel injector 160 starts with a “pull-in” phase. The “pull-in” phase is created by employing the boost voltage V_{boost} provided by the boost converter 520. In the “pull-in” phase, the movable needle 167 is actuated by the solenoid 165 acting as a control valve and it is risen to open the fuel injector 160. The “pull-in” phase is generally followed by a short “peak phase” in which the current oscillates between two current levels and in which the solenoid 165 of the fuel injector 160 is energized by the battery voltage V_{batt} of the battery 500, In some embodiments, the peak phase can be very short or even neglected.

According to an embodiment of the present disclosure, after this short peak phase, the polarity of the voltage of the boost converter 520 is inverted and such inverted boost voltage Vᵢₙᵥ_{_}_{boost} is applied to the solenoid 165 of the fuel injector 160. This operation is indicated as “boost inversion” phase of FIG. 4. This operation has the effect of slowing down the injector's needle 167 during the opening phase of the fuel injector 160. The timing of the boost inversion phase can be modulated in order to obtain a desired fuel injection shape of the rate of injection.

Then, a second opening phase of the injector 160 is performed by employing the boost voltage V_{boost} provided by the boost converter 520, as indicated in the “boost voltage” phase of FIG. 4. Then a “hold phase” is performed in which the current oscillates between two current levels and in which the power supply is typically the battery voltage V_{batt} of battery 500. Finally, at the end of the “hold phase”, the solenoid 165 of the fuel injector 160 is de-energized and the fuel injector 160 is closed.

The steps of inverting the polarity of the boost voltage V_{boost} and of applying the inverted boost voltage Vᵢₙᵥ_{_}_{boost} to the solenoid 165 of the injector 160 allow for a rapid discharging of the energy from the solenoid 165. The timing of this phase can be modulated to create a desired injection rate shape as a function of current profile.

As an alternative, the step of discharging the energy from the solenoid 165 of the fuel injector 160 is performed by naturally discharging the energy from the solenoid 165, or in other words is performed by preventing any voltage supply to the solenoid 165 for a calibratable period of time in order to allow the discharge of the solenoid 165.

In order to better understand the benefits given by the various embodiment of the present disclosure, in FIG. 5 a schematic illustration of two injection rate profiles C and C′ for two different fuel injections is represented, Both injection rate profiles C and C′ are obtained by means of different embodiment of the present disclosure, In ellipse E are indicated the shapes of the injection rate profiles C and C′ that are obtained as a consequence of applying the above mentioned “boost inversion” and “boost voltage” phases of FIG. 4. In this way, fine timing of the injection rate shape change can be obtained. Such a shape of the rate of injection is defined by the combustion requirements on the basis of the engine operating point.

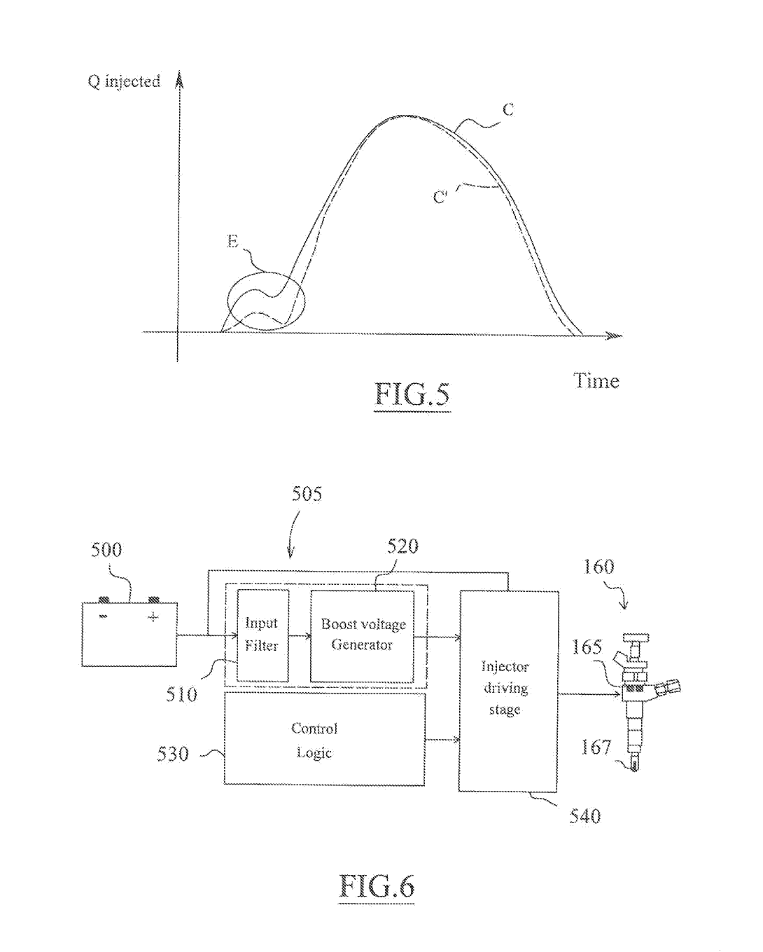

FIG. 6 is a schematic illustration of a circuit 505 employed to perform the various embodiments of the present disclosure to generate a boost voltage V_{boost} and an inverted boost voltage Vᵢₙᵥ_{_}_{boost}. Circuit 505 is powered by the battery voltage V_{batt} of the battery 500 and includes a microprocessor to operate a control logic 530 to perform steps of the various embodiments of the method, an input filter 510, a boost converter 520 that converts a battery voltage V_{batt} into a boost voltage V_{boost} and a hardware device 540 to drive the fuel injector 160.

FIG. 7 is a schematic illustration of a current profile A″ for a fuel injection performed according to still another embodiment of the present disclosure. The current profile A″ of FIG. 7 is similar to the current profile A′ of FIG. 4, with the difference that, in lieu of performing the “boost voltage” phase of FIG. 4, after the “boost inversion” phase, the second opening phase of the fuel injector 160 is performed by employing the battery voltage V_{batt} provided by the battery 500, as indicated by the “battery voltage” phase of FIG. 7.

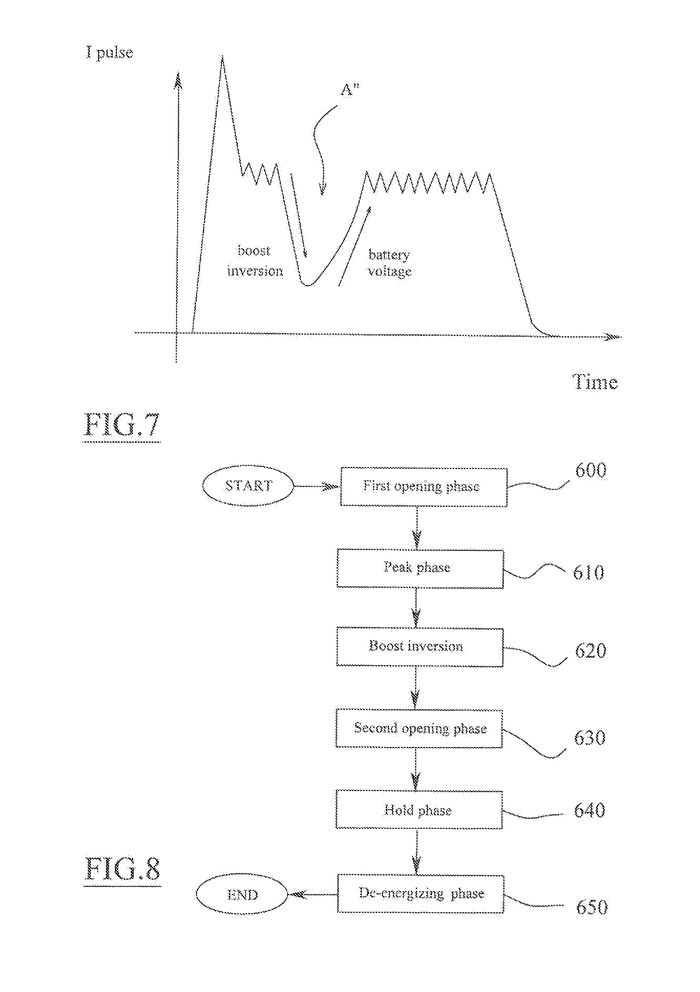

FIG. 8 is a flowchart representing an embodiment of a method of the present disclosure. A first step of an embodiment of the present disclosure is the first opening phase of the fuel injector 160, obtained by providing a boost voltage V_{boost} to the solenoid 165 of the fuel injector 160 (block 600). The first opening phase is then followed by the peak phase (block 610) and then by the boost inversion phase (block 620) employing an inverted boost voltage Vᵢₙᵥ_{_}_{boost}. A second opening phase is then performed (block 630), the second opening phase being performed, alternatively, either by employing a boost voltage V_{boost} or by employing a battery voltage V_{batt}. Then a hold phase is performed (block 630) and, finally, the fuel injector 160 is de-energized (block 650).

By allowing to modulate the shape of the fuel injection rate profile, a combustion efficiency improvement is obtained which leads to a sensible CO₂ reduction and to an improvement in the reduction of engine noise. In some automotive systems the CO₂reduction may be around 1% and the reduction of engine noise may be around 3 dB.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended Claims and their legal equivalents.

1-11. (canceled)

12. A method of energizing a fuel injector of an internal combustion engine having a battery configured to provide a battery voltage to the fuel injector and a boost converter configured to provide a boost voltage higher than the battery voltage to the solenoidal fuel injector, the method comprising:
applying the boost voltage to a solenoid of the fuel injector to perform a first opening phase of the fuel injector;
discharging energy from the solenoid of the fuel injector;
applying a second voltage to the solenoid of the fuel injector to perform a second opening phase of the fuel injector;
applying the battery voltage to the solenoid of the fuel injector to perform a hold phase of the fuel injector; and
performing a closing phase of the fuel injector.

13. The method according to claim 12, wherein discharging energy from the solenoid comprises inverting the polarity of the boost voltage, and applying the inverted boost voltage to the solenoid of the fuel injector.

14. The method according to claim 13, further comprises performing a peak phase after the first opening phase of the fuel injector is performed and before energy is discharged from the solenoid.

15. The method according to claim 12, wherein discharging energy from the solenoid of the fuel injector comprises preventing any voltage supply to the solenoid.

16. The method according to claim 12, wherein the second opening phase of the fuel injector is performed by applying the boost voltage to the solenoid of the fuel injector.

17. The method according to claim 12, wherein the second opening phase of the fuel injector is performed by applying the battery voltage to the solenoid of the fuel injector.

18. The method according to claim 12, further comprising applying the inverted boost voltage to the solenoid of the fuel injector for a time period based a desired fuel injection shape.

20. A non-transitory computer readable medium comprising a computer-code, which when executed on a processor is configured to perform the method according to claim 1.

21. A control apparatus for an internal combustion engine, comprising an electronic control unit, a data carrier including the non-transitory computer readable medium according to claim 20 associated to the electronic control unit.

22. An apparatus for energizing a fuel injector for an internal combustion engine, the fuel injector being electrically connected to a battery configured to provide a battery voltage and to a boost converter configured to provide a boost voltage, wherein the boost voltage is higher than the battery voltage, the apparatus comprising an electronic control unit configured to:
apply the boost voltage to solenoid of the fuel injector to perform a first opening phase of the fuel injector;
discharge energy from the solenoid of the fuel injector;
apply a second voltage to the solenoid of the fuel injector to perform a second opening phase of the fuel injector;
apply the battery voltage to the solenoid of the fuel injector to perform a hold phase of the fuel injector; and
perform a closing phase of the fuel injector.
